(19) United States
(12) Patent Application Publication
(10) Pub. No.: US 2008/0282553 A1
(43) Pub. Date: Nov. 20, 2008

(54) Hedge trimmer

(75) Inventors: Clifford J. Woody, Utica, MI (US); Matthew S. Bartochowski, Cheektowaga, NY (US)

Correspondence Address: SIMPSON & SIMPSON, PLLC, 5555 MAIN STREET, WILLIAMSVILLE, NY, 14221-5406, US

(73) Assignee: JRB Machine-Tool, Inc., Lancaster, NY (US)

(21) Appl. No.: 12/150,800

(22) Filed: May 1, 2008

Related U.S. Application Data
(60) Provisional application No. 60/928,190, filed on May 8, 2007.

(51) Int. Cl. B25F 5/00

(52) U.S. Cl. 30/276

(57) ABSTRACT

A blade for a hedge trimmer, including: a front portion with an edge; a rear portion in contact with the front portion and bent at an angle with respect to the front portion; and a first concavely shaped cutting surface along at least a segment of the edge. In a first embodiment, the front and rear portions include a distally disposed edge and the blade includes a second concavely shaped cutting surface along at least a segment of the distally disposed edge. In a second embodiment, the first and second concavely shaped cutting surfaces are continuous one with the other. In a third embodiment, the rear portion is bent at an angle of between 10 degrees and 30 degrees with respect to the front portion. In a fourth embodiment, the rear portion is bent at an angle of 20 degrees with respect to the front portion.

### CROSS-REFERENCE TO RELATED APPLICATIONS

This application claims the benefit under 35 U.S.C. § 119(e) of U.S. Provisional Application No. 60/928,190 filed May 8, 2007, which application is incorporated herein by reference.

### FIELD OF THE INVENTION

The present invention relates generally to a blade for a hedge trimmer, in particular, to a blade having a concave cutting surface and an angled profile.

### BACKGROUND OF THE INVENTION

Scissors-type power hedge trimmers are known. These trimmers have reciprocating blades that act in the same manner as scissors. Unfortunately, the clippings created by these trimmers fall to the ground or, worse yet, inside the hedge or bush that is being trimmed. Therefore, the clippings must be retrieved in a separate, and often lengthy process, once the actual trimming is completed.

Rotary blade power hedge trimmers are known in the art. Unfortunately, the blades for such trimmers create undesirably large trimmings. That is, the trimmers do not “mulch” the trimmings into smaller, more easily handled pieces. Further, if the trimmer includes a collection reservoir, such as a bag, the undesirably large pieces can jam the opening or chute for the bag. In general, the cutting surfaces for rotary blades are inefficient. Some designs use a flexible “string” type cutter, for example, as found on “weed whackers.” Unfortunately, the cutting capacity of such trimmers is limited and the string must be constantly played out and replaced.

Therefore, what is needed is a blade for a hedge trimmer that efficiently cuts material while enhancing the capability of the hedge trimmer to control and manipulate cuttings.

### BRIEF SUMMARY OF THE INVENTION

The present invention broadly comprises a blade for a hedge trimmer, including: a front portion with an edge; a rear portion in contact with the front portion and bent at an angle with respect to the front portion; and a first concavely shaped cutting surface along at least a segment of the edge. In a first embodiment, the front and rear portions include a distally disposed edge and the blade includes a second concavely shaped cutting surface along at least a segment of the distally disposed edge. In a second embodiment, the first and second concavely shaped cutting surfaces are continuous one with the other. In a third embodiment, the rear portion is bent at an angle of between 10 degrees and 30 degrees with respect to the front portion. In a fourth embodiment, the rear portion is bent at an angle of 20 degrees with respect to the front portion. In a fifth embodiment, the blade includes a single piece of material including the front and rear portions.

The present invention also broadly comprises a blade for a hedge trimmer, including: a center portion and at least three blade portions extending from the center portion. Each of the blade portions includes a front segment and a rear segment, the rear segment is in contact with the front segment and is bent at an angle with respect to the front segment, the front segment includes an edge and a first concavely shaped cutting surface along at least a part of the edge. In a first embodiment, each blade portion includes a distal, with respect to the center portion, edge, and a second concavely shaped cutting surface along at least a part of the distal edge. In a second embodiment, the front and rear segments include the distal edge. In a third embodiment, the first and second concavely shaped cutting surfaces are continuous one with the other. In a fourth embodiment, the rear portion is bent at an angle of between 10 degrees and 30 degrees with respect to the front portion. In a fifth embodiment, the rear portion is bent at an angle of 20 degrees with respect to the front portion.

The present invention further broadly comprises a method for operating a blade for a hedge trimmer

A general object of the present invention is to provide a hedge trimmer that efficiently cuts material while enhancing the capability of the hedge trimmer to control and manipulate cuttings.

This and other objects, features and advantages of the present invention will become readily apparent to those having ordinary skill in the art from a reading and study of the following detailed description of the invention, in view of the drawing and appended claims.

### BRIEF DESCRIPTION OF THE DRAWINGS

The nature and mode of operation of the present invention will now be more fully described in the following detailed description of the invention taken with the accompanying drawing figures, in which:

FIG. 1 is a top view of a present invention blade;

FIG. 2 is a side view of the blade shown in FIG. 1;

FIG. 3 is a cross-sectional view of the blade shown in FIG. 1 taken generally along line 3-3 in FIG. 1;

FIG. 4 is an exploded view of the blade shown in FIG. 1 in a hedge trimmer housing;

FIG. 5 is a side view of the housing shown in FIG. 4; and,

FIG. 6 is a cross-sectional view of the housing shown in FIG. 5 taken generally along line 6-6 in FIG. 5.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

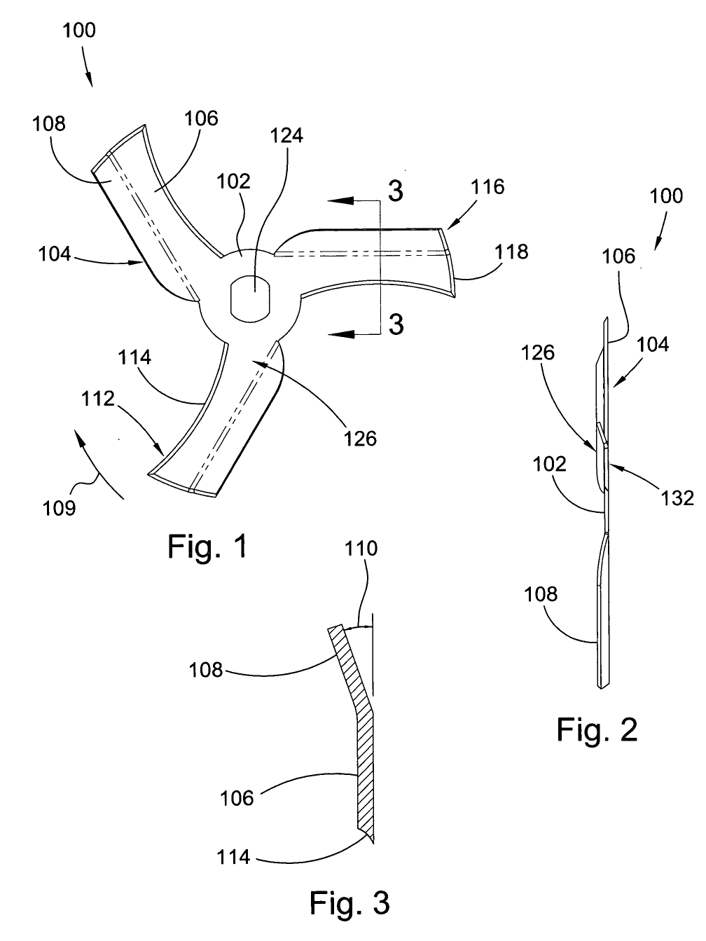

FIG. 1 is a top view of present invention blade 100.

FIG. 2 is a side view of blade 100 shown in FIG. 1.

FIG. 3 is a cross-sectional view of an embodiment of blade 100 shown in FIG. 1 taken generally along line 3-3 in FIG. 1. The following should be viewed in light of FIGS. 1 through 3. Blade 100 includes center portion 102 and at least three blade portions 104 extending from the center portion. Each of the blade portions includes front segment 106 and rear segment 108. Front and rear are with respect to an expected direction of rotation of the blade, for example, direction 109. Specifically, the front segment would lead the read segment in the expected rotational direction. Although a clockwise direction is shown for 109, it should be understood that 109 could be counterclockwise and the configuration of blade 100 adjusted accordingly.

The front and rear segments are in contact, for example, the segments are continuous one with the other. The rear segment is bent at angle 110 with respect to the front portion. In a first embodiment, angle 110 is between 10 degrees and 30 degrees. In a second embodiment, angle 110 is 20 degrees. The front segment includes edge 112 and concavely shaped cutting surface 114 along at least a part of the edge. Although a particular concavity is shown for surface 114, it should be understood that other concave configurations for surface 114 are included in the spirit and scope of the claimed invention. Each blade portion includes distal edge 116. Distal is defined with respect to the center portion. The front and rear segments include the distal edge. In one embodiment, at least a portion of edge 116 includes concavely shaped cutting surface 118. In another embodiment, surface 118 is disposed along all of edge 116. In a further embodiment, concavely shaped cutting surfaces 114 and 118 are continuous one with the other. That is, the surfaces run together or a connected together and have substantially the same concave shape. It should be understood that surface 118 can have a different concavity than surface 114 and that any concave shape known in the art can be used for surface 118.

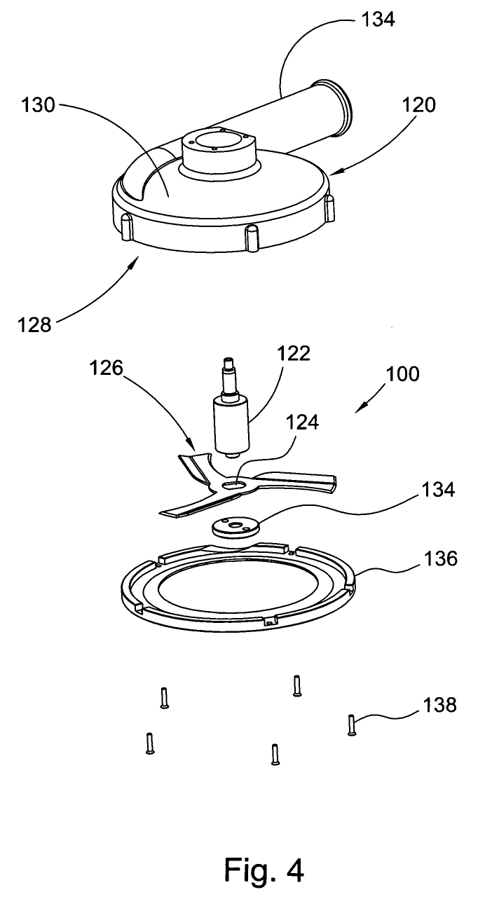

FIG. 4 is an exploded view of blade 100 shown in FIG. 1 in hedge trimmer housing 120.

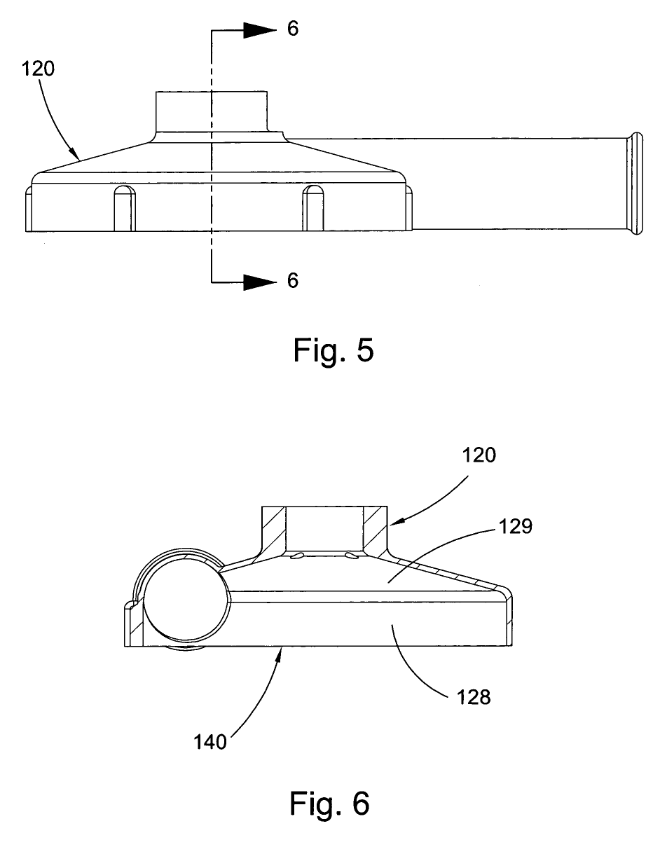

FIG. 5 is a side view of housing 120 shown in FIG. 4.

FIG. 6 is a cross-sectional view of housing 120 shown in FIG. 5 taken generally along line 6-6 in FIG. 5. The following should be viewed in light of FIGS. 1 through 6. Blade 100 is connectable to a power shaft for a hedge trimmer by any means known in the art. In a first embodiment, the center portion is connectable to power shaft 122 for a hedge trimmer (not shown) by sliding the shaft into opening 124. In general, top surface 126 of the blade faces the main body of the hedge trimmer, for example, the top surface generally faces housing 120. Thus, in a second embodiment, the rear segment is bent at least partly toward the interface of the shaft and the hedge trimmer body. Alternately stated, the rear segment extends further into cavity 128 of the housing. It should be understood that a present invention blade is not limited to use with the housing and shaft shown in FIG. 4 and that use of a present invention blade with other configurations and combinations of hedge trimmer components is within the spirit and scope of the claimed invention.

Although three equally spaced blade portions 104 are shown in the figures, it should be understood that other numbers and spacings of blade portions are within the spirit and scope of the claimed invention.

The rear segments, or “spoilers” advantageously create an updraft during operation of a hedge trimmer equipped with blade 100. The updraft creates a vacuum effect in the housing. That is, the rear segments decrease pressure within the housing, in particular at upper end 129 of cavity 128, partly formed by portion 130 of the housing, creating a pressure differential between the cavity and the area outside the cavity, for example, the area adjacent to bottom face 132 of the blade. The rear segments extend beyond the plane formed by the front segments (that is, as blade 100 circulates, the front segments rotate is a plane and the rear segments extend beyond this plane). This extension in conjunction with the pressure differential causes debris, or cuttings, created by contact of the blade with material to be cut, to circulate in the housing before being ejected through chute 134. The circulation of the debris advantageously results in the debris being cut into smaller pieces by the blade. The finer pieces are easier to handle and are more readily compostable, usable as mulch, or otherwise disposable. That is, the mulching operation of the hedge trimmer is accentuated.

The pressure differential also draws material to be cut toward the housing. For example, when a hedge trimmer equipped with blade 100 is used to cut branches, the pressure differential advantageously draws the branches toward the blade. Also, the pressure differential keeps debris in the housing, increasing the amount of debris that is passed through the chute and rather than falling away from the housing.

The blade can be made of any material known in the art. In one embodiment, the blade is made from a cold rolled steel stamping. In another embodiment, the blades portions are formed with a curved configuration. In a further embodiment, the blades are formed, or sharpened, to a 4″ radius which allows for a larger cutting surface.

In one embodiment, blade 100 is secured to shaft 122 by any fastener known in the art, for example, fastener 134, and shroud 136 is connected to the housing by any means known in the art, for example, threaded fasteners 138, to partially cover opening 140 of the housing.

The present invention also includes a method for operating a blade for a hedge trimmer including a center portion and at least three blade portions extending from the center portion. Each of the blade portions includes a front segment and a rear segment, the rear segment is in contact with the front segment and is bent at an angle with respect to the front portion, the front segment includes an edge and a first concavely shaped cutting surface along at least a part of the edge, and the blade is disposed in a housing. Although the method is depicted as a sequence for clarity, no order should be inferred from the sequence unless explicitly stated. A first step rotates the blade so that the respective edges lead the respective rear segments and a second step displaces air in the housing with the rear segment to reduce pressure in the housing. In a first embodiment, each blade portion includes a distal, with respect to the center portion, edge, and a second concavely shaped cutting surface along at least a part of the distal edge. In a second embodiment, the front and rear segments include the distal edge. In a third embodiment, the first and second concavely shaped cutting surfaces are continuous one with the other. In a fourth embodiment, the rear portion is bent at an angle of between 10 degrees and 30 degrees with respect to the front portion. In a fifth embodiment, the rear portion is bent at an angle of 20 degrees with respect to the front portion.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A blade for a hedge trimmer, comprising:
a front portion with an edge;
a rear portion in contact with the front portion and bent at an angle with respect to the front portion; and,
a first concavely shaped cutting surface along at least a segment of the edge.

2. The blade of claim 1 wherein the front and rear portions include a distally disposed edge and the blade further comprising a second concavely shaped cutting surface along at least a segment of the distally disposed edge.

3. The blade of claim 2 wherein the first and second concavely shaped cutting surfaces are continuous one with the other.

4. The blade of claim 1 wherein the rear portion is bent at an angle of between 10 degrees and 30 degrees with respect to the front portion.

5. The blade of claim 4 wherein the rear portion is bent at an angle of 20 degrees with respect to the front portion.

6. The blade of claim 1 further comprising a single piece of material including the front and rear portions.

7. A blade for a hedge trimmer, comprising:
a center portion; and,
at least three blade portions extending from the center portion, wherein each of the blade portions includes a front segment and a rear segment, wherein the rear segment is in contact with the front segment and is bent at an angle with respect to the front portion, wherein the front segment includes an edge and a first concavely shaped cutting surface along at least a part of the edge.

8. The blade of claim 7 wherein each blade portion includes a distal, with respect to the center portion, edge, and a second concavely shaped cutting surface along at least a part of the distal edge.

9. The blade of claim 8 wherein the front and rear segments include the distal edge.

10. The blade of claim 8 wherein the first and second concavely shaped cutting surfaces are continuous one with the other.

11. The blade of claim 7 wherein the rear portion is bent at an angle of between 10 degrees and 30 degrees with respect to the front portion.

12. The blade of claim 11 wherein the rear portion is bent at an angle of 20 degrees with respect to the front portion.

13. The blade of claim 7 wherein the center portion is connectable to a shaft extending from a hedge trimmer body and wherein the rear segment is bent at least partly toward the interface of the shaft and the hedge trimmer body.

14. A method for operating a blade for a hedge trimmer, the blade including a center portion and at least three blade portions extending from the center portion, wherein each of the blade portions includes a front segment and a rear segment, wherein the rear segment is in contact with the front segment and is bent at an angle with respect to the front segment, wherein the front segment includes an edge and a first concavely shaped cutting surface along at least a part of the edge, and wherein the blade is disposed in a housing, comprising the steps of:
rotating the blade so that the respective edges lead the respective blade portions; and,
displacing air with the rear segment to reduce pressure in the housing.

15. The blade of claim 14 wherein each blade portion includes a distal, with respect to the center portion, edge, and a second concavely shaped cutting surface along at least a part of the distal edge.

16. The blade of claim 15 wherein the front and rear segments include the distal edge.

17. The blade of claim 15 wherein the first and second concavely shaped cutting surfaces are continuous one with the other.

18. The blade of claim 14 wherein the rear portion is bent at an angle of between 10 degrees and 30 degrees with respect to the front portion.

19. The blade of claim 18 wherein the rear portion is bent at an angle of 20 degrees with respect to the front portion.
